(19) United States
(12) Patent Application Publication
(10) Pub. No.: US 2025/0379715 A1
(43) Pub. Date: Dec. 11, 2025

(54) SYSTEMS, METHODS, AND DEVICES FOR SMART UL RESOURCE SELECTION ALGORITHM FOR TDD PROBLEMATIC BANDS

(71) Applicant: Apple Inc., Cupertino, CA (US)

(72) Inventors: Priyank GUPTA P, Bangalore (IN); Abhay A. JOSHI, Cupertino, CA (US); Amit DUBEY, San Diego, CA (US); Vijay VENKATARAMAN, San Jose, CA (US)

(21) Appl. No.: 19/226,465

(22) Filed: Jun. 3, 2025

Related U.S. Application Data
(60) Provisional application No. 63/656,970, filed on Jun. 6, 2024.

(51) Int. Cl. H04L 5/14; H04W 72/0446

(52) U.S. Cl. CPC H04L 5/1438; H04W 72/0446

(57) ABSTRACT

Techniques are provided for intelligently allocating uplink resources for TDD problematic bands. A UE may perform conflict avoidance procedures and/or prioritization of uplink resources associated with a problematic band combination. When the UE is scheduled to perform uplink and downlink corresponding to a slot associated with a combination of problematic bands, the UE may forgo transmitting of the uplink communication. The UE may configure flexible slots to avoid such conflicts and/or to prioritize critical downlink and/or uplink communication. resolving and/or mitigating interference associated with a problematic band combination. These and many other features and examples are described.

### CROSS-REFERENCE TO RELATED APPLICATIONS

This application claims the benefit of U.S. Provisional Application No. 63/656,970, filed Jun. 6, 2024, the content of which is incorporated herein by reference in its entirety for all purposes.

### FIELD

This disclosure relates to wireless communication networks and devices.

### BACKGROUND

Wireless communication networks and wireless communication services are becoming increasingly dynamic, complex, and ubiquitous. For example, some wireless communication networks may be developed to implement fifth generation (5G) or new radio (NR) technology, sixth generation (6G) technology, and so on. Such technology may include solutions for enabling network nodes and access points to communicate with one another in a variety of ways. In some scenarios, UEs may communicate with a plurality of base stations.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example process for resolving problematic TDD band combinations, according to one or more implementations described herein.

FIG. 2 is a diagram of an example network according to one or more implementations described herein.

FIG. 3 is a diagram of an example process for resolving problematic TDD band combinations according to one or more implementations described herein.

FIG. 4 is a diagram of an example of potential problematic TDD band combinations, according to one or more implementations described herein. FIG. 5 is a diagram of example slot precedence rules according to one or more implementations described herein.

FIG. 6 is a diagram of an example process for resolving problematic TDD band combinations according to one or more implementations described herein.

FIG. 7 is a diagram of an example process for resolving problematic TDD band combinations according to one or more implementations described herein.

FIG. 8 is a diagram of an example process for resolving problematic TDD band combinations according to one or more implementations described herein.

FIG. 9 is a diagram of a process of a UE resolving problematic TDD band combinations according to one or more implementations described herein.

FIG. 10 is a diagram of a process of a base station transmitting configuration information and receiving information associated with problematic TDD band combinations according to one or more implementations described herein.

FIG. 11 is a diagram of an example of components of a device according to one or more implementations described herein.

FIG. 12 is a diagram of example interfaces of baseband circuitry according to one or more implementations described herein.

FIG. 13 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Wireless networks may include user equipment (UEs) capable of communicating with base stations, wireless routers, satellites, and other network nodes. Such devices may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). A UE may refer to a smartphone, tablet computer, wearable wireless device, a vehicle capable of wireless communications, and/or another type of a broad range of wireless-capable device.

Wireless resources may be structured and organized according to frames, subframes, slots, symbols, and the like. A frame may have a duration of 10 milliseconds (ms) and may have 10 subframes, each of which may have a duration of 1 ms. Each subframe may have 2 slots, and each slot may consist of 14 orthogonal frequency-division multiplexing (OFDM) symbols. Using time division duplexing, frames may be transmitted continuously, and each subframe may be of a fixed duration (i.e., 1 ms). However, slot length may vary based on subcarrier spacing and the number of slots per subframe.

A physical resource block (PRB) may be a fundamental unit of radio resource allocation in wireless communication systems. A PRB may consist of a group of contiguous subcarriers in the frequency domain and a set of consecutive time slots in the time domain. The number of subcarriers and time slots of a PRB may vary depending on the specific deployment scenario and configuration. The data transmitted over PRBs may be organized into transport blocks, which may be encapsulated into radio frames for transmission over the air interface. The size of the transport blocks may determine the amount of data that can be transmitted in each PRB.

A resource element (RE) may be the smallest unit of the resource grid. An RE may consist of one subcarrier in the frequency domain and one OFDM symbol in time domain. A resource block (RB) is defined only for a frequency domain as 12 (N_RB_sc) consecutive subcarriers in the frequency domain. Time domain definition of a resource block is a minimum time domain length in a resource block can be one OFDM symbol, but may vary.

Slots may be configured for uplink or downlink when configured for the time domain. A slot configured for time division duplexing (TDD) may be configured to be reserved for downlink symbols, uplink symbols, or may be flexibly reserved for uplink or downlink.

LTE and/or 5GNR wireless operating bands may be specified for operation of the UE supporting evolved universal mobile telecommunications system terrestrial radio access network (E-UTRAN) dual connectivity (EN-DC). EN-DC communication may include the UE transmitting to and/or receiving signals from a plurality of base stations. In some scenarios, the EN-DC communication may include using a first radio access technology (RAT) carrier and also using a second RAT carrier to concurrently transmit and/or receive information with a plurality of base stations. A first base station may serve as a master LTE node, and a second base station may serve as a secondary node. The UE may support NR E-UTRA (NE-DC) communication, in which a first base station serves as a 5GNR primary cell and a second base station serves as a LTE secondary cell. Thus, in some scenarios, the UE may support concurrent communication with a plurality of base stations.

Some combinations of concurrent and/or temporally overlapping uplink and downlink between a plurality of base stations and the UE may cause interference between uplink and downlink slots. For example, the UE may be scheduled to communicate with the plurality of base stations using a TDD uplink slot corresponding to a first band and a TDD downlink slot that also corresponds to the first band. If the UE communicates in accordance with the initial scheduling, RF power may undesirably couple from transmit circuitry facilitating the uplink communication to receive circuitry facilitating the downlink communication, thus causing intermodulation interference. Intermodulation interference caused by the concurrent uplink and downlink slots of similar or the same frequency bands may be referred to as “problematic band combinations,” which may cause unwanted reductions in data throughput to and/or from the UE. Current solutions fail to resolve and/or mitigate prospective intermodulation interference in such scenarios.

Techniques described herein address the deficiencies of currently available technology by providing solutions that enable a UE to reduce and/or avoid intermodulation interference between problematic band combinations, and/or intelligently use uplink resources for important uplink data. In some scenarios, the UE may process and generate TDD patterns and/or map between various combinations of uplink, downlink, and/or flexible slots to prioritize downlink slots when a problematic band combination may be scheduled. In some scenarios, the UE may detect a problematic band conflict between concurrent uplink and downlink slots, and may forgo transmitting of symbols using that uplink slot. In some scenarios, the UE may determine that a flexible slot is scheduled to be concurrent with an uplink slot and/or that critical uplink data should be communicated to a base station. In such scenarios, the UE may reconfigure the flexible slots to correspond to uplink slots for the critical uplink data, thus reducing the likelihood that the critical uplink data interferes with any downlink communication. Thus, the UE may preferentially configure the flexible slots for uplink instead of configuring the flexible slots for downlink. These and many other features and examples are described below with reference to the Figures.

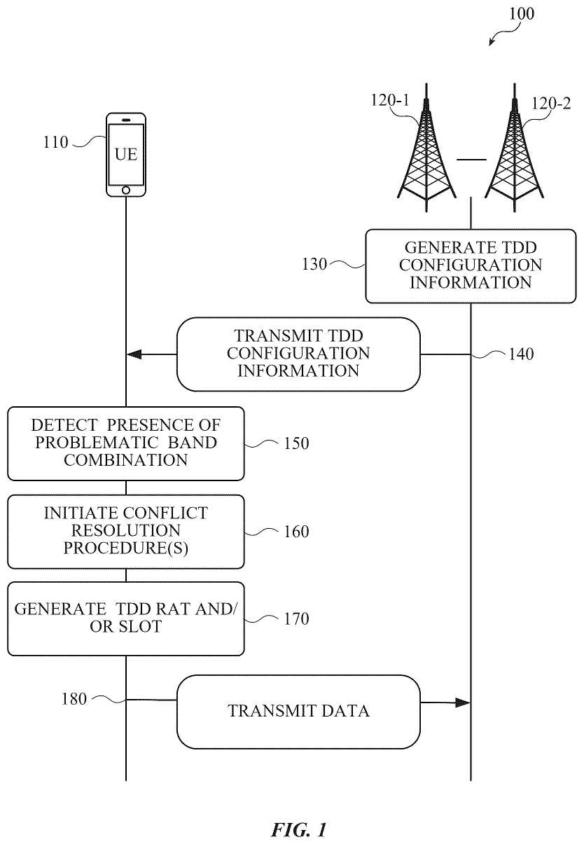

FIG. 1 is a diagram of an example process for resolving problematic TDD band combinations, according to one or more implementations described herein. As shown, overview 100 may include UE 110, base station 120-1, and base station 120-2. In some implementations, UE 110 may be in communication with base station 120-1 and/or 120-2, such as via EN-DC. It is understood that description of communication between UE 110 and base station 120-1 may apply to communication between UE 110 and base station 120-2.

In some scenarios, base station 120-1 may generate TDD configuration information (at 130). The configuration information may specify the number of downlink slots, uplink slots, uplink symbols, downlink symbols, periodicity, cell ID, frequency band, TDD sub frame assignment, and the like. In some scenarios, base station 120-1 may transmit the TDD configuration information to UE 110 (at 140). In some scenarios, LTE TDD configuration information includes one or more predefined patterns of uplink, downlink, and/or flexible slots. In some scenarios, 5GNR TDD configuration information does not include one or more predefined patterns. In some scenarios, the UE 110 determines that slots not expressly designated as an uplink or a downlink slot in accordance with the LTE TDD configuration information correspond to flexible slot that may be configured as uplink or downlink slots, in accordance with the UE's knowledge of the presence of additional slots corresponding to different carriers that may present a problematic band conflict.

In some scenarios, UE 110 determines the presence of a problematic band combination (at 150). As described above, the problematic band combination may include a determination that when time-multiplexed, UE 110 is responsible for transmitting and receiving on a same, or similar TDD frequency band that may cause undesirable interference between circuitry used to transmit signals coupling to circuitry used to receive signals. In some scenarios, UE 110 initiates conflict resolution procedure(s) to reduce and/or avoid the possibility that communication with base station 120-1 and base station 120-2 may present a problematic band combination. For example, UE 110 may be configured in dual connectivity mode with a first RAT corresponding to base station 120-1 and a second RAT corresponding to base station 120-2, such as both corresponding to a similar or same frequency band. In some implementations, UE 110 may initiate conflict resolution procedures (at 160). The conflict resolution procedures may include forgoing transmitting during an uplink slot in favor of maintaining receiving during the downlink slot, and/or delay the transmitting to another uplink slot and/or configuring a flexible slot as an uplink slot. In some scenarios, in UE 110 determines the manner in which slots in a subframe will be allocated (e.g., for downlink only or for uplink only) and generates the TDD RAT(s) and/or slots in accordance with the conflict resolution procedure(s) (at 170). UE 110 may thereafter initiate transmission and/or reception of symbols corresponding to the determined slot patterns (at 180).

The techniques described herein also include other features and solutions. For example, the techniques described herein include solutions for specifying prioritization of important uplink data, and the corresponding configuration of flexible slots to facilitate the transmission of the important uplink data. Additionally or alternatively, the techniques described herein include solutions for configuring flexible slots as downlink slots, to improve downlink direction throughput. Accordingly, many additional features and benefits of the techniques described herein are discussed below with reference to the examples and figures that follow.

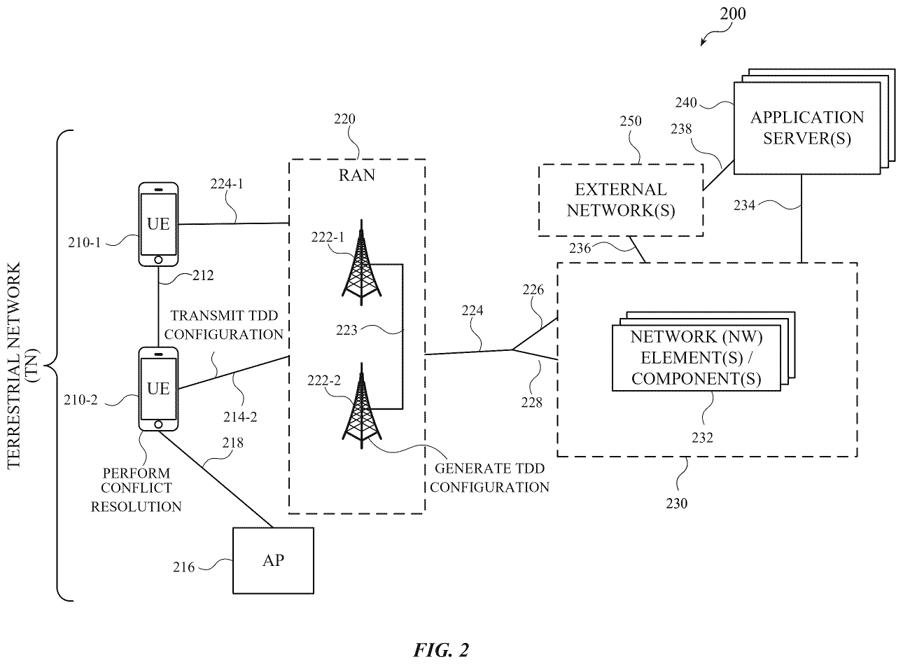

FIG. 2 is an example network 200 according to one or more implementations described herein. Example network 200 may include UEs 210-1, 210-2, etc. (referred to collectively as “UEs 210” and individually as “UE 210”), a radio access network (RAN) 220, a core network (CN) 230, application servers 240, and external networks 250.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 may include smartphones (e.g., handheld touchscreen mobile computing devices connectable to one or more wireless communication networks). Additionally, or alternatively, UEs 210 may include other types of mobile or non-mobile computing devices capable of wireless communications, such as personal data assistants (PDAs), pagers, laptop computers, desktop computers, wireless handsets, etc. In some implementations, UEs 210 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 210 may communicate and establish a connection with one or more other UEs 210 via one or more wireless channels 212, each of which may comprise a physical communications interface/layer. The connection may include an M2M connection, MTC connection, D2D connection, SL connection, etc. The connection may involve a PC5 interface. In some implementations, UEs 210 may be configured to discover one another, negotiate wireless resources between one another, and establish connections between one another, without intervention or communications involving RAN node 222 or another type of network node. In some implementations, discovery, authentication, resource negotiation, registration, etc., may involve communications with RAN node 222 or another type of network node.

UEs 210 may use one or more wireless channels 212 to communicate with one another. As described herein, UE 210-1 may communicate with RAN node 222 to request SL resources. RAN node 222 may respond to the request by providing UE 210 with a dynamic grant (DG) or configured grant (CG) regarding SL resources. A DG may involve a grant based on a grant request from UE 210. A CG may involve a resource grant without a grant request and may be based on a type of service being provided (e.g., services that have strict timing or latency requirements). UE 210 may perform a clear channel assessment (CCA) procedure based on the DG or CG, select SL resources based on the CCA procedure and the DG or CG; and communicate with another UE 210 based on the SL resources. The UE 210 may communicate with RAN node 222 using a licensed frequency band and communicate with the other UE 210 using an unlicensed frequency band.

UEs 210 may communicate and establish a connection with (e.g., be communicatively coupled) with RAN 220, which may involve one or more wireless channels 214-1 and 214-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 222-1 and 222-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 230. Additionally, at least one of the MN or the SN may be operated with shared spectrum channel access, and functions specified for UE 210 can be used for an integrated access and backhaul mobile termination (IAB-MT). Similar for UE 210, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 222.

In some scenarios, UE 210 may perform one or more operations to avoid interference caused by problematic band combinations. The operation(s) may include mutual exclusivity of downlink or uplink directions, such as prioritizing the downlink direction by forgoing performance of uplink transmissions to the base station (e.g., RAN node 222-2) when an uplink slot and a downlink slot presenting the problematic band combination are scheduled to be concurrent. In some scenarios, the UE 210 additionally or alternatively may determine the presence of uplink data in a transmit buffer, and may perform operations to prioritize the transmission of the uplink data using flexible slots.

As shown, UE 210 may also, or alternatively, connect to access point (AP) 216 via connection interface 218, which may include an air interface enabling UE 210 to communicatively couple with AP 216. AP 216 may comprise a wireless local area network (WLAN), WLAN node, WLAN termination point, etc. The connection via AP 216 may comprise a local wireless connection, such as a connection consistent with any IEEE 702.11 protocol, and AP 216 may comprise a wireless fidelity (Wi-Fi®) router or other AP. While not explicitly depicted in FIG. 1, AP 216 may be connected to another network (e.g., the Internet) without connecting to RAN 220 or CN 230. In some scenarios, UE 210, RAN 220, and AP 216 may be configured to utilize LTE-WLAN aggregation (LWA) techniques or LTE WLAN radio level integration with IPsec tunnel (LWIP) techniques. LWA may involve UE 210 in RRC_CONNECTED being configured by RAN 220 to utilize radio resources of LTE and WLAN. LWIP may involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling may include encapsulating the entirety of original IP packets and adding a new packet header, thereby protecting the original header of the IP packets.

RAN 220 may include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 may include a roadside unit (RSU), a transmission reception point (TRxP or TRP), and one or more other types of ground stations (e.g., terrestrial access points). In some scenarios, RAN node 222 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 222; a media access control (MAC)/physical (PHY) layer split wherein RRC, PDCP, radio link control (RLC), and MAC layers may be operated by the CRAN/vBBUP and the PHY layer may be operated by individual RAN nodes 222; or a “lower PHY” split wherein RRC, PDCP, RLC, MAC layers and upper portions of the PHY layer may be operated by the CRAN/vBBUP and lower portions of the PHY layer may be operated by individual RAN nodes 222. This virtualized framework may allow freed-up processor cores of RAN nodes 222 to perform or execute other virtualized applications.

In some implementations, an individual RAN node 222 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server located in RAN 220 or by a server pool (e.g., a group of servers configured to share resources) in a similar manner as the CRAN/vBBUP. Additionally, or alternatively, one or more of RAN nodes 222 may be next generation eNBs (i.e., gNBs) that may provide evolved universal terrestrial radio access (E-UTRA) user plane and control plane protocol terminations toward UEs 210, and that may be connected to a 5G core network (5GC) 230 via an NG interface.

Any of the RAN nodes 222 may terminate an air interface protocol and may be the first point of contact for UEs 210. In some implementations, any of the RAN nodes 222 may fulfill various logical functions for the RAN 220 including, but not limited to, radio network controller (RNC) functions such as radio bearer management, uplink (UL) and downlink (DL) dynamic radio resource management and data packet scheduling, and mobility management. UEs 210 may be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 222 to UEs 210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 222 may be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed band or spectrum may include the 5 GHz band. In an additional or alternative example, an unlicensed spectrum may include the 5 GHz unlicensed band, a 6 GHz band, a 60 GHz millimeter wave band, and more.

A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 may operate using stand-alone unlicensed operation, licensed assisted access (LAA), eLAA, and/or feLAA mechanisms. In these implementations, UEs 210 and the RAN nodes 222 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The PDSCH may carry user data and higher layer signaling to UEs 210. The physical downlink control channel (PDCCH) may carry information about the transport format and resource allocations related to the PDSCH channel, among other things. The PDCCH may also inform UEs 210 about the transport format, resource allocation, and hybrid automatic repeat request (HARQ) information related to the uplink shared channel. Typically, downlink scheduling (e.g., assigning control and shared channel resource blocks to UE 210-2 within a cell) may be performed at any of the RAN nodes 222 based on channel quality information fed back from any of UEs 210. The downlink resource assignment information may be sent on the PDCCH used for (e.g., assigned to) each of UEs 210.

The PDCCH uses control channel elements (CCEs) to convey the control information, wherein several CCEs (e.g., 6 or the like) may consists of a resource element groups (REGs), where a REG is defined as a physical resource block (PRB) in an OFDM symbol. Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 222 may be configured to communicate with one another via interface 223. In implementations where the system is an LTE system, interface 223 may be an X2 interface. In NR systems, interface 223 may be an Xn interface. In some implementations, such as a standalone (SA) implementation, interface 223 may be an Xn interface. In some implementations, such as non-standalone (NSA) implementations, interface 223 may represent an X2 interface and an XN interface. The X2 interface may be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface may include an X2 user plane interface (X2-U) and an X2control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 220 may be connected (e.g., communicatively coupled) to CN 230. CN 230 may comprise a plurality of network elements 232, which are configured to offer various data and telecommunications services to customers/subscribers (e.g., users of UEs 210) who are connected to the CN 230 via the RAN 220. In some implementations, CN 230 may include an evolved packet core (EPC), a 5G CN, and/or one or more additional or alternative types of CNs. The components of the CN 230 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 230 may be referred to as a network slice, and a logical instantiation of a portion of the CN 230 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 230, application servers 240, and external networks 250 may be connected to one another via interfaces 234, 236, and 238, which may include IP network interfaces. Application servers 240 may include one or more server devices or network elements (e.g., virtual network functions (VNFs) offering applications that use IP bearer resources with C2 230 (e.g., universal mobile telecommunications system packet services (UMTS PS) domain, LTE PS data services, etc.). Application servers 240 may also, or alternatively, be configured to support one or more communication services (e.g., voice over IP (VoIP sessions, push-to-talk (PTT) sessions, group communication sessions, social networking services, etc.) for UEs 210 via the CN 230. Similarly, external networks 250 may include one or more of a variety of networks, including the Internet, thereby providing the mobile communication network and UEs 210 of the network access to a variety of additional services, information, interconnectivity, and other network features.

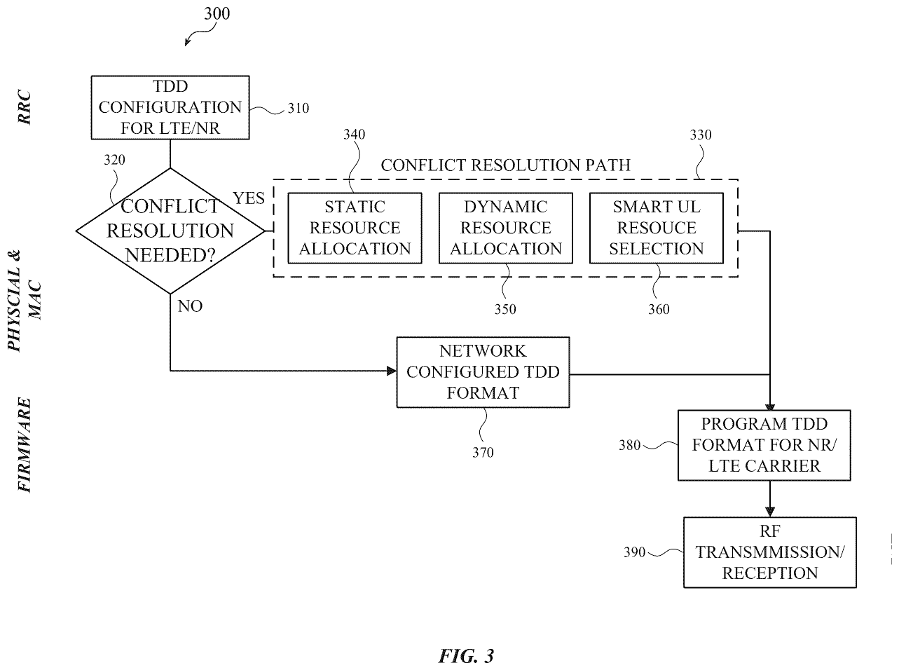

FIG. 3 is a diagram of an example process for resolving problematic TDD band combinations according to one or more implementations described herein. Process 300 may include receiving a TDD configuration for LTE and/or NR at UE 210 (at 310). In some scenarios, the TDD configuration is included in a RRC message received from base station (e.g., RAN node 222-2). In some scenarios, the TDD configuration indicates the number of downlink slots, uplink slots, periodicity, and the like included in a NR and/or LTE TDD configuration. In some scenarios, the TDD configuration indicates a pattern of uplink, downlink, and/or flexible slots, such as for a LTE TDD configuration.

In some scenarios, UE 210 determines whether conflict resolution is required (at 320). In some scenarios, UE 210 utilizes the MAC layer to determine if dual connectivity between RAN node 222-1 and RAN node 222-2 may introduce a conflict between uplink and downlink scheduled to be concurrent during a same slot, as described with reference to FIG. 3. In some scenarios, UE 210 determines that a conflict is absent (at 320—No), and may proceed to implement the network configured TDD format (at 370) for scheduling transmission via the physical layer. For example, UE 210 may program the TDD format obtained from base station (e.g., RAN node 222-2) to firmware of UE 210 (at 380). In some scenarios, UE 210 may transmit and/or receive in a manner determined in accordance with the programmed TDD format (at 390).

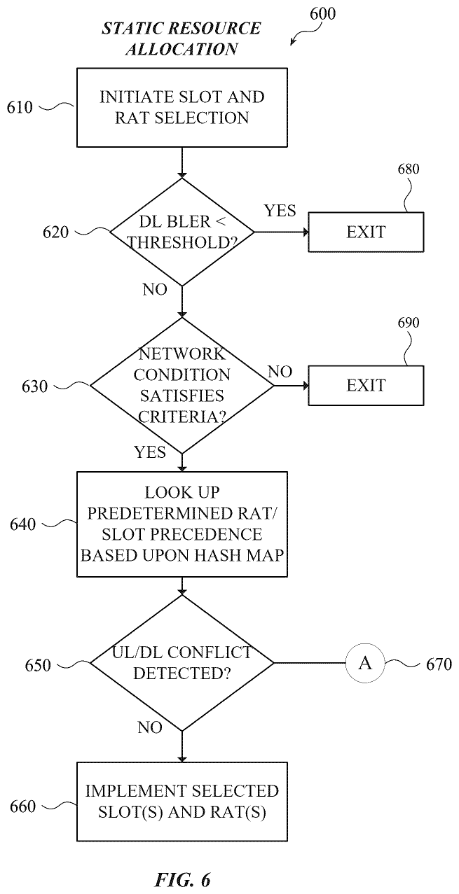

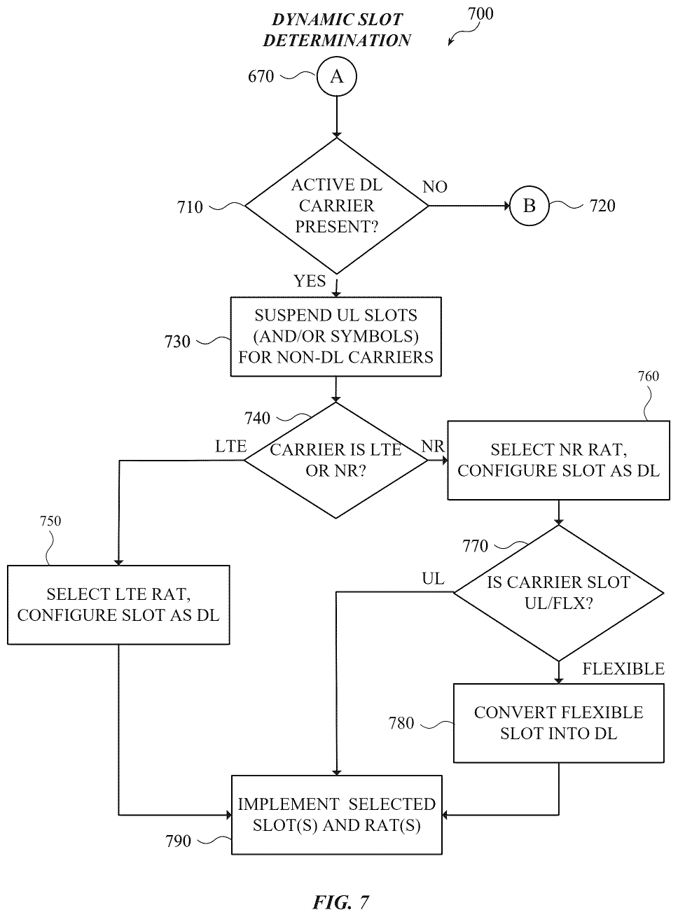

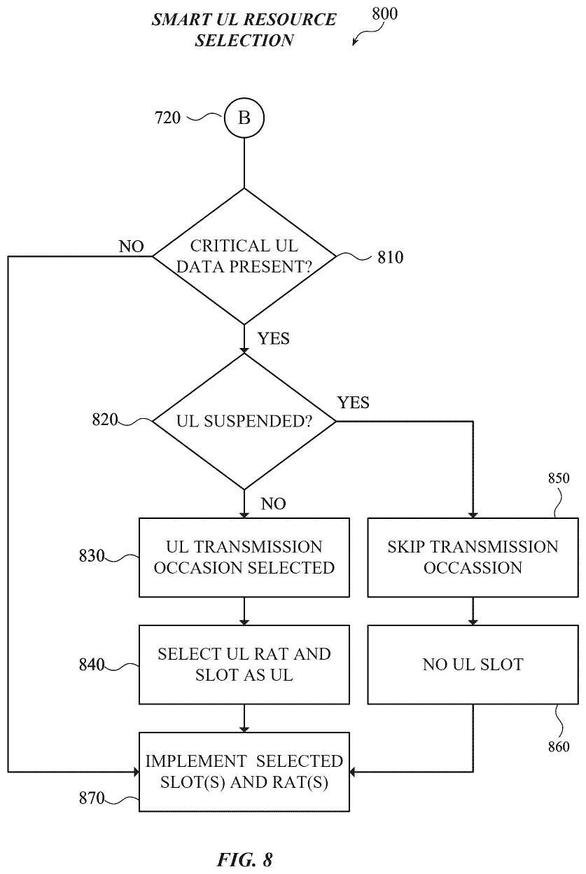

In some scenarios, UE 210 determines that a conflict is present and conflict resolution between at least one set of uplink and downlink slots and/or symbols may be required (at 320—Yes). In some scenarios, UE 210 initiates one or more procedures included in a “Conflict Resolution Path” (at 330). In some scenarios, the conflict resolution path includes static resource allocation (at 340), as described with reference to FIG. 6, dynamic slot selection (at 350) as described with reference to FIG. 7, and/or smart uplink (UL) resource selection (at 360) as described with reference to FIG. 8. In some scenarios, based upon the various modifications to the TDD format determined by UE 210, UE 210 proceeds to program firmware of circuitry included in UE 210 implementing the modified TDD format (at 380). In some scenarios, UE 210 may transmit and/or receive in a manner determined in accordance with the programmed TDD format modified in accordance with the conflict resolution path (at 390).

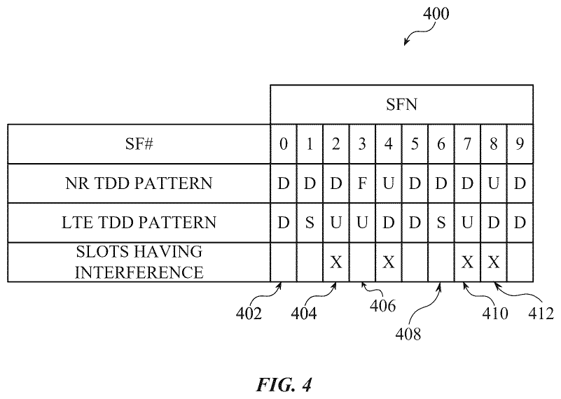

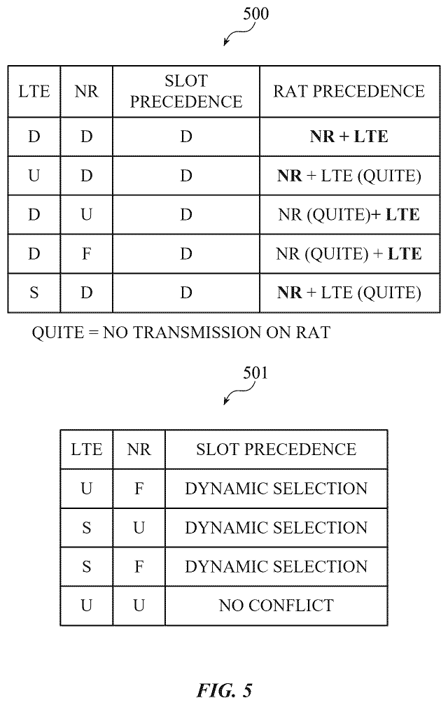

FIG. 4 is a diagram of an example of potential problematic TDD band combinations, according to one or more implementations described herein. Table 400 illustrates a system frame (“SFN”), which includes a plurality of indexed subframes (“SF”). In FIG. 4, a given subframe corresponds to a single slot, but it is understood that additional or alternative subdivisions of a subframe may be contemplated without departing from the scope of the disclosure. In some scenarios, the UE 210 temporally aligns the slots between LTE RAT and a 5GNR RAT, and determines whether potentially problematic conflicting slot directions are scheduled. For example, UE 210 determines that slot 402 (e.g., subframe #1) corresponds to a scenario in which both the NR and the TDD patterns correspond to a downlink direction (“D”). Accordingly, slot 402 may not correspond to a prospective interference scenario. Similarly, UE 210 may determine that at slot 406 (e.g., subframe #3), a flexible NR slot (“F”) may be allocated for uplink and a TDD uplink slot is scheduled (“U”). Accordingly, UE 210 may determine slot 406 may not correspond to a prospective interference scenario. Slot 408 illustrates a similar scenario, in which the LTE TDD pattern is left flexibly up to the UE 210 (“S”), which UE 210 may configure as downlink in view of the corresponding NR slot being a downlink slot.

In some scenarios, UE 210 determines that conflicting directions associated with a TDD band are scheduled. For example, UE 210 determines that at slot 404, the NR RAT will correspond to a downlink direction, and that the LTE RAT will correspond to an uplink direction. As described herein, UE 210 accordingly determines that slot 404 may present a relatively high interference scenario due to the conflicting communication link directions if the UE 210 operations in dual connectivity mode as scheduled. Similarly, slots 410 and 412 correspond to similar scenarios as described with reference to slot 404. In particular, a LTE RAT is in a first communication link direction, and a NR RAT is configured in a second, conflicting direction.

FIG. 5 is a diagram of example slot precedence rules according to one or more implementations described herein. For example, UE 210 may preferentially prioritize downlink due to the sensitivity of receivers, filters, low-noise amplifiers, and/or some combination thereof to the relatively larger power being generated by power amplifiers and/or transmit filters facilitating the uplink communication. Table 500 illustrates a scenario in which UE 210 determines a hash table map to resolve problematic TDD band combinations. In particular, table 500 illustrates that when UE 210 is configured to receive communication corresponding to a given slot, UE 210 may prioritize the reception of the communication. As a simple example, when both a LTE and a NR RAT are configured in the downlink direction, UE 210 is configured to concurrently receive communication from both RATs (e.g., LTE “D” and NR “D”, corresponding to a pair of downlinks slots). In contrast, when UE 210 determines that a first RAT will correspond to an uplink direction and a second RAT will correspond to a downlink direction, UE 210 may be configured to prioritize the downlink direction (e.g., LTE “U” and NR “D” or LTE “D” and NR “U,” corresponding to an uplink slot that is scheduled to be concurrent with a downlink slot). In some scenarios UE 210 prioritizes the downlink direction by suppressing transmission corresponding to the first RAT (e.g., configuring the UE 210 to correspond to a discontinuous transmission (DTX) mode for the associated slot).

In some scenarios, when a given rat corresponds to a flexible slot configuration (e.g., “F” and/or “S”), UE 210 may be configured to prioritize downlink communication. It is understood UE 210 may preferentially give the RAT corresponding to the downlink direction precedence, in a manner similar to as described with reference the slot preference herein. For example, when the NR and LTE both correspond to a downlink direction the RAT Precedence is equal, because there may not be a conflict between uplink and downlink. Additionally or alternatively, when the LTE slot corresponds to the uplink direction “U” and the NR slot corresponds to the downlink direction (D), the NR RAT is given precedence, and the LTE RAT may not be used to transmit (e.g., corresponding to “LTE (QUITE)”). It is understood that reference to “QUITE” in table 500 may refer to the forgoing of transmitting in the uplink direction. For brevity, it is understood that the RAT preference optionally corresponds to the slot precedence in table 500.

Table 501 illustrates scenarios in which UE 210 determines that a downlink slot does not correspond to a given slot number, and may dynamically determine the slot configuration in accordance with procedures described further herein. For example, a flexible NR slot may be dynamically configured when a concurrent LTE slot is configured for uplink. Additionally or alternatively, a flexible LTE slot may be dynamically configured when a concurrent NR slot is configured for uplink. In some scenarios, both slots are flexible, and UE 210 may configure both slots in accordance with prioritization of uplink or downlink, such as prioritizing uplink in accordance with a determination that critical uplink data is buffered. Thus, when a NR slot is flexible or a LTE slot is flexible, and another slot corresponding to another RAT carrier corresponds to an uplink or flexible configuration, UE 210 may dynamically configure the flexible slot(s) (e.g., to both correspond to uplink, such as when critical data may be buffered at UE 210). In some scenarios, when both LTE and NR RAT carriers correspond to an uplink direction, no conflict exists, and UE 210 is free to transmit in dual connectivity mode.

FIG. 6 is a diagram of an example process for resolving problematic TDD band combinations according to one or more implementations described herein. Process 600 can be implemented by UE 210. In some implementations, some or all of process 600 can be performed by one or more other systems or devices, including one or more of the systems or devices of FIGS. 2 and/or 11-13. Additionally, process 600 can include one or more fewer, additional, differently ordered and/or arranged operations than those shown in FIG. 6. Some or all of the operations of process 600 can be performed independently, successively, simultaneously, etc., of one or more of the other operations of process 600. Further, one or more of the operations of process 600 can include one or more of the features, conditions, information, characteristics, etc., described elsewhere herein. As such, the techniques described herein are not limited to the number, sequence, arrangement, timing, type, etc., of the operations or processes depicted in FIG. 6.

In some scenarios, UE 210 performs process 600, which may include conflict resolution procedure(s) and/or may include dynamic slot allocation to allocate the resources indicated by configuration information received from RAN node 222. For example, UE 210 may initiate a process to select the slot and/or RAT configurations that may be used when communicating with RAN node 222 in dual connectivity mode (at 610). In some scenarios, UE 210 determines whether downlink block error rate (BLER) is less a than a threshold amount (at 620). In some scenarios, when BLER is greater than the threshold amount (at 620—Yes), UE 210 ceases performance of the process 600 (at 680), and/or returns to again verify whether the BLER is greater than the threshold. In some scenarios, when BLER is less than or equal to the threshold amount (at 620—No), UE 210 determines whether the network operating conditions satisfies one or more criteria (e.g., a channel condition parameter satisfies the one or more criteria) (at 630). In some scenarios, the one or more criteria include a criterion that is satisfied when one or more of a reference signal received power (RSRP) reference signals received quality (RSRQ), and/or a signal to interference ratio (SIR) are within a range of values, above threshold values, and/or below threshold values. In some scenarios, when the network conditions do not satisfy the one or more criteria (at 630—No), UE 210 ceases the procedure (at 690) and/or returns back to step 630 to verify whether the network condition satisfies the criteria. In some scenarios, when the network conditions do satisfy the one or more criteria (at 630—Yes), UE 210 generates and/or cross-references a hash map table, such as table 400, to the various combinations of concurrent slots corresponding to respective RAT carriers. Thus, UE 210 may determine that key performance indicators (KPI) are satisfied.

In some scenarios, UE 210 looks up the static resource allocation described with reference to FIG. 5, corresponding to a predetermined slot precedence that is associated with a hash map (at 640). In such scenarios, UE 210 may identify the presence or absence of conflicting link directions (at 650). In some scenarios, UE 210 may determine that a conflict does not exist, and may forgo performing superfluous conflict avoidance procedure(s), and may proceed to prepare a transport block, including programming and/or configuring slots with appropriate symbols for respective RAT carriers, thereby implementing the TDD configuration (at 660). In some scenarios, UE 210 detects an uplink and downlink conflict (at 650—No), and in response, initiates further operations and/or procedures (at 670). In some scenarios, when a conflict is detected, UE 210 configures flexible slots to correspond to downlink slots and/or schedules to forgo transmitting of uplink symbols during uplink slots that conflict with downlink slots, as described with reference to FIG. 5.

FIG. 7 is a diagram of an example process for resolving problematic TDD band combinations according to one or more implementations described herein. Process 700 can be implemented by UE 210. In some implementations, some or all of process 700 can be performed by one or more other systems or devices, including one or more of the systems or devices of FIGS. 2 and/or 11-13. Additionally, process 700 can include one or more fewer, additional, differently ordered and/or arranged operations than those shown in FIG. 6. Some or all of the operations of process 700 can be performed independently, successively, simultaneously, etc., of one or more of the other operations of process 700. Further, one or more of the operations of process 700 can include one or more of the features, conditions, information, characteristics, etc., described elsewhere herein. As such, the techniques described herein are not limited to the number, sequence, arrangement, timing, type, etc., of the operations or processes depicted in FIG. 7.

FIG. 7 illustrates additional operations and/or procedures related to process 600, such as dynamic resource selection initiated in response to the determination that UE 210 detects the uplink and downlink conflict and/or that an active downlink carrier is present (at 650, and at 710). In some scenarios, UE 210 may determine that the active DL carrier is present (e.g., that there is a presence of a DL slot corresponding to a first RAT carrier that conflicts with an uplink slot). In some scenarios, UE 210 may determine that there is not an active DL carrier and/or that there is not a conflict between a UL and a DL slot (at 720—No) and may perform additional or alternative operations, such as suspending uplink slots and/or symbols, thereby preparing to implement a TDD configuration in which the conflict uplink slots and/or symbols are suppressed (at 730). In some scenarios, UE 210 may determine whether one or more RAT carriers that are being analyzed are LTE or NR RATs. In some scenarios, UE 210 determines that the RAT is a LTE RAT (at 740—LTE), and may configure some or all scheduled flexible slot(s) as downlink slots to improve downlink throughput (at 750).

In some scenarios, UE 210 determines that the RAT is a NR RAT (at 740—NR), and may select the NR RAT in order to potentially configure flexible and/or uplink slots as downlink slots. In some scenarios, UE 210 determines whether one or more correspond to uplink slots or flexible slots (at 770). In some scenarios, UE 210 determines that the slot is a UL slot (at 770—UL). In such scenarios, UE 210 may configure the TDD configuration to suppress the identified UL transmission for the corresponding slot. In some scenarios, UE 210 determines that the slot is a flexible slot (at 770—Flexible). In such scenarios, UE 210 may configure the flexible slots to be downlink slots (at 780). Thus, UE 210 may configure flexible slots to improve downlink throughput, in addition to avoiding an uplink and downlink conflict. In some scenarios, based upon the suspended UL slots and/or the conversion of flexible slots to be configured as downlink slots, UE 210 may proceed to prepare the transport block, including programming and/or implementing slots with appropriate symbols for respective RAT carriers (at 790).

FIG. 8 is a diagram of an example process for resolving problematic TDD band combinations according to one or more implementations described herein. Process 700 can be implemented by UE 210. In some implementations, some or all of process 800 can be performed by one or more other systems or devices, including one or more of the systems or devices of FIGS. 2 and/or 11-13. Additionally, process 800 can include one or more fewer, additional, differently ordered and/or arranged operations than those shown in FIG. 8. Some or all of the operations of process 800 can be performed independently, successively, simultaneously, etc., of one or more of the other operations of process 800. Further, one or more of the operations of process 800 can include one or more of the features, conditions, information, characteristics, etc., described elsewhere herein. As such, the techniques described herein are not limited to the number, sequence, arrangement, timing, type, etc., of the operations or processes depicted in FIG. 8.

FIG. 8 illustrates additional operations and/or procedures related to process 600 and/or 700, such as intelligent uplink resource selection, which may be initiated in response to the determination that UE 210 detects a lack of an uplink and downlink conflict for one or more pairs of concurrent slots corresponding to respective RAT carriers (at 650—no and/or at 710—no). In some scenarios, UE 210 may determine whether critical data is pending in the UE, such as buffered for later multiplexing into transport blocks (at 810). In some scenarios, UE 210 may determine that critical data is buffered (at 820—yes). In some scenarios, UE 210 may determine whether uplink has been suspended in accordance with a previous determination made by UE 210 (at 820). In some scenarios, UE 210 determines that uplink has been suspended (at 820—Yes) and may schedule a skipping of a transmission occasion (at 850) corresponding to an uplink slot under analysis (at 860). In some scenarios, UE 210 determines that uplink has not been suspended (at 820—No). In some scenarios, UE 210 may select a transmission occasion and/or slot (at 830) and may select and/or implement the selected slot as uplink for the relevant RAT carrier (at 840). In some scenarios, UE 210 may additionally or alternatively convert flexible slot(s) to be configured to facilitate the critical uplink transmission. In some scenarios, the critical uplink transmission includes one or more of a random access channel (RACH) request, a re-transmission of one or more symbols, data indicated to be associated with low-latency communication, and/or a scheduling request (SR). In some scenarios, the critical uplink corresponds to one or more symbols associated with a re-transmission of data, voice over new radio (VoNR), voice over long-term evolution (VoLTE), ultra-reliable low latency communications (URLLC), augmented reality (AR) data, mixed reality (XR) data, and/or virtual reality (VR) data. For example, UE 210 may determine that a flexible slot is scheduled to be concurrent with an uplink slot, and/or that two flexible slots are scheduled to be concurrent, and may schedule the RACH and/or the SR request to correspond to the flexible slot(s). Independently of whether the UE 210 prioritizes the critical uplink transmission, UE 210 may proceed to prepare the transport block, including programming and/or implementing slots with appropriate symbols for respective RAT carriers (at 870).

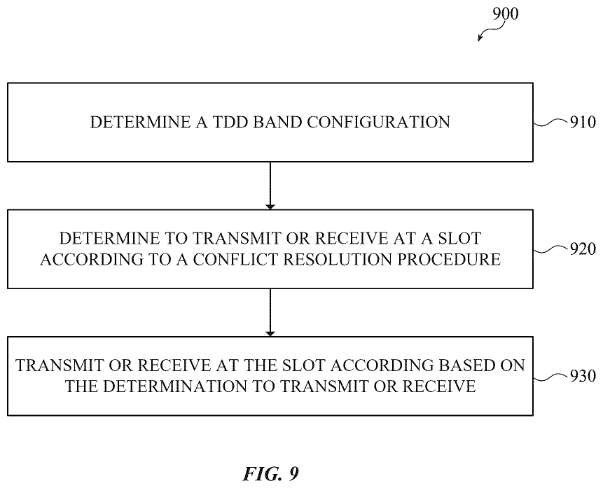

FIG. 9 is a diagram of a process of a UE resolving problematic TDD band combinations according to one or more implementations described herein. Example process 900 may include determining a TDD band configuration at the UE (at 910). The process 900 may include determining to transmit or receive at a slot according to a conflict resolution procedure (at 920), and may include determining to transmit or receive at the slot based on the determination to transmit or receive (at 930).

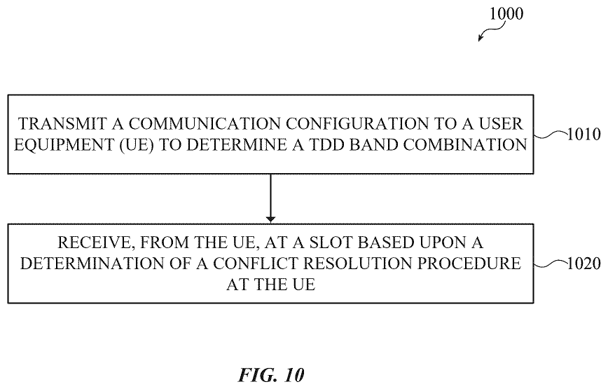

FIG. 10 is a diagram of a process of a RAN node 222 transmitting configuration information and receiving information associated with problematic TDD band combinations according to one or more implementations described herein. Example process 1000 may include transmitting a communication configuration to a user equipment (UE) to determine a TDD band combination (at 1010), and may include receiving from the UE, at a slot based upon a determination of a conflict resolution procedure performed at the UE (at 1020).

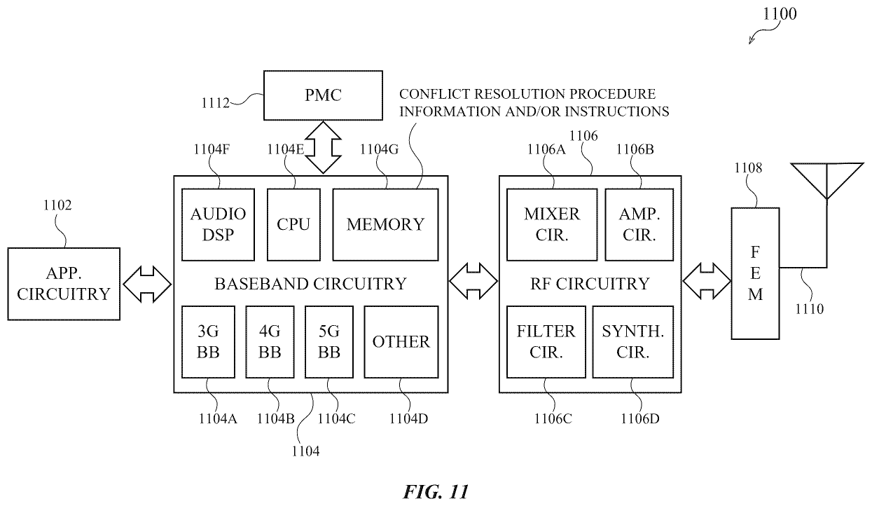

FIG. 11 is a diagram of an example of components of a device according to one or more implementations described herein. In some implementations, the device 1100 can include application circuitry 1102, baseband circuitry 1104, RF circuitry 1106, front-end module (FEM) circuitry 1108, one or more antennas 1110, and power management circuitry (PMC) 1112 coupled together at least as shown. The components of the illustrated device 1100 can be included in a UE or a RAN node. In some implementations, the device 1100 can include fewer elements (e.g., a RAN node may not utilize application circuitry 1102, and instead include a processor/controller to process IP data received from a CN or an Evolved Packet Core (EPC)). In some implementations, the device 1100 can include additional elements such as, for example, memory/storage, display, camera, sensor (including one or more temperature sensors, such as a single temperature sensor, a plurality of temperature sensors at different locations in device 1100, etc.), or input/output (I/O) interface. In other implementations, the components described below can be included in more than one device (e.g., said circuitries can be separately included in more than one device for Cloud-RAN (C-RAN) implementations).

The application circuitry 1102 can include one or more application processors. For example, the application circuitry 1102 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1100. In some implementations, processors of application circuitry 1102 can process IP data packets received from an EPC.

The baseband circuitry 1104 can include circuitry such as, but not limited to, one or more single-core or multi-core processors. The baseband circuitry 1104 can include one or more baseband processors or control logic to process baseband signals received from a receive signal path of the RF circuitry 1106 and to generate baseband signals for a transmit signal path of the RF circuitry 1106. Baseband circuity 1104 can interface with the application circuitry 1102 for generation and processing of the baseband signals and for controlling operations of the RF circuitry 1106. For example, in some implementations, the baseband circuitry 1104 can include a 3G baseband processor 1104A, a 4G baseband processor 1104B, a 5G baseband processor 1104C, or other baseband processor(s) 1104D for other existing generations, generations in development or to be developed in the future (e.g., 5G, 6G, etc.). The baseband circuitry 1104(e.g., one or more of baseband processors 1104A-D) can handle various radio control functions that enable communication with one or more radio networks via the RF circuitry 1106. In other implementations, some or all of the functionality of baseband processors 1104A-D can be included in modules stored in the memory 1104G and executed via a Central Processing Unit (CPU) 1104E. The radio control functions can include, but are not limited to, signal modulation/demodulation, encoding/decoding, radio frequency shifting, etc. In some implementations, modulation/demodulation circuitry of the baseband circuitry 1104 can include Fast-Fourier Transform (FFT), precoding, or constellation mapping/de-mapping functionality. In some implementations, encoding/decoding circuitry of the baseband circuitry 1104 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1104G may receive and store one or more configurations, instructions, and/or other types of information to enable conflict avoidance procedures and/or prioritization of uplink resources associated with a problematic band combination. When the UE is scheduled to perform uplink and downlink corresponding to a slot associated with a combination of problematic bands, the UE may forgo transmitting of the uplink communication. The UE may configure flexible slots to avoid such conflicts and/or to prioritize critical downlink and/or uplink communication. These and many other features and examples are described herein and may be enabled by the configurations, instructions, and/or other types of information stored by memory 1104G.

In some implementations, the baseband circuitry 1104 can include one or more audio digital signal processor(s) (DSP) 1104F. The audio DSPs 1104F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1104 and the application circuitry 1102 can be implemented together such as, for example, on a system on a chip (SOC).

In some implementations, the baseband circuitry 1104 can provide for communication compatible with one or more radio technologies. For example, in some implementations, the baseband circuitry 1104 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1104 is configured to support radio communications of more than one wireless protocol can be referred to as multi-mode baseband circuitry.

RF circuitry 1106 can enable communication with wireless networks using modulated electromagnetic radiation through a non-solid medium. In various implementations, the RF circuitry 1106 can include switches, filters, amplifiers, etc. to facilitate the communication with the wireless network. RF circuitry 1106 can include a receive signal path which can include circuitry to down-convert RF signals received from the FEM circuitry 1108 and provide baseband signals to the baseband circuitry 1104. RF circuitry 1106 can also include a transmit signal path which can include circuitry to up-convert baseband signals provided by the baseband circuitry 1104 and provide RF output signals to the FEM circuitry 1108 for transmission.

In some implementations, the receive signal path of the RF circuitry 1106 can include mixer circuitry 1106A, amplifier circuitry 1106B and filter circuitry 1106C. In some implementations, the transmit signal path of the RF circuitry 1106 can include filter circuitry 1106C and mixer circuitry 1106A. RF circuitry 1106 can also include synthesizer circuitry 1106D for synthesizing a frequency for use by the mixer circuitry 1106A of the receive signal path and the transmit signal path. In some implementations, the mixer circuitry 1106A of the receive signal path can be configured to down-convert RF signals received from the FEM circuitry 1108 based on the synthesized frequency provided by synthesizer circuitry 1106D. The amplifier circuitry 1106B can be configured to amplify the down-converted signals and the filter circuitry 1106C can be a low-pass filter (LPF) or band-pass filter (BPF) configured to remove unwanted signals from the down-converted signals to generate output baseband signals. Output baseband signals can be provided to the baseband circuitry 1104 for further processing. In some implementations, the output baseband signals can be zero-frequency baseband signals, although this is not a requirement. In some implementations, mixer circuitry 1106A of the receive signal path can comprise passive mixers, although the scope of the implementations is not limited in this respect.

In some implementations, the mixer circuitry 1106A of the transmit signal path can be configured to up-convert input baseband signals based on the synthesized frequency provided by the synthesizer circuitry 1106D to generate RF output signals for the FEM circuitry 1108. The baseband signals can be provided by the baseband circuitry 1104 and can be filtered by filter circuitry 1106C.

In some implementations, the mixer circuitry 1106A of the receive signal path and the mixer circuitry 1106A of the transmit signal path can include two or more mixers and can be arranged for quadrature down conversion and up conversion, respectively. In some implementations, the mixer circuitry 1106A of the receive signal path and the mixer circuitry 1106A of the transmit signal path can include two or more mixers and can be arranged for image rejection (e.g., Hartley image rejection). In some implementations, the mixer circuitry 1106A of the receive signal path and the mixer circuitry 1406A can be arranged for direct down conversion and direct up conversion, respectively. In some implementations, the mixer circuitry 1106A of the receive signal path and the mixer circuitry 1106A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 1106 can include analog-to-digital converter (ADC) and digital-to-analog converter (DAC) circuitry and the baseband circuitry 1104 can include a digital baseband interface to communicate with the RF circuitry 1106.

In some dual-mode implementations, a separate radio IC circuitry can be provided for processing signals for each spectrum, although the scope of the implementations is not limited in this respect.

In some implementations, the synthesizer circuitry 1106D can be a fractional-N synthesizer or a fractional N/N+1 synthesizer, although the scope of the implementations is not limited in this respect as other types of frequency synthesizers can be suitable. For example, synthesizer circuitry 1106D can be a delta-sigma synthesizer, a frequency multiplier, or a synthesizer comprising a phase-locked loop with a frequency divider.

The synthesizer circuitry 1106D can be configured to synthesize an output frequency for use by the mixer circuitry 1106A of the RF circuitry 1106 based on a frequency input and a divider control input. In some implementations, the synthesizer circuitry 1106D can be a fractional N/N+1 synthesizer.

In some implementations, frequency input can be provided by a voltage-controlled oscillator (VCO), although that is not a requirement. Divider control input can be provided by either the baseband circuitry 1104 or the applications circuitry 1102 depending on the desired output frequency. In some implementations, a divider control input (e.g., N) can be determined from a look-up table based on a channel indicated by the applications circuitry 1102.

Synthesizer circuitry 1106D of the RF circuitry 1106 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1106D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1106 can include an IQ/polar converter.

FEM circuitry 1108 can include a receive signal path which can include circuitry configured to operate on RF signals received from one or more antennas 1110, amplify the received signals and provide the amplified versions of the received signals to the RF circuitry 1106 for further processing. FEM circuitry 1108 can also include a transmit signal path which can include circuitry configured to amplify signals for transmission provided by the RF circuitry 1106 for transmission by one or more of the one or more antennas 1110. In various implementations, the amplification through the transmit or receive signal paths can be done solely in the RF circuitry 1106, solely in the FEM circuitry 1108, or in both the RF circuitry 1106 and the FEM circuitry 1108.

In some implementations, the FEM circuitry 1108 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1106). The transmit signal path of the FEM circuitry 1108 can include a power amplifier (PA) to amplify input RF signals (e.g., provided by RF circuitry 1106), and one or more filters to generate RF signals for subsequent transmission (e.g., by one or more of the one or more antennas 1110).

In some implementations, the PMC 1112 can manage power provided to the baseband circuitry 1104. In particular, the PMC 1112 can control power-source selection, voltage scaling, battery charging, or DC-to-DC conversion. The PMC 1112 can often be included when the device 1100 is capable of being powered by a battery, for example, when the device is included in a UE. The PMC 1112 can increase the power conversion efficiency while providing desirable implementation size and heat dissipation characteristics.

While FIG. 11 shows the PMC 1112 coupled only with the baseband circuitry 1104. However, in other implementations, the PMC 1112 may be additionally or alternatively coupled with, and perform similar power management operations for, other components such as, but not limited to, application circuitry 1102, RF circuitry 1106, or FEM circuitry 1108.

In some implementations, the PMC 1112 can control, or otherwise be part of, various power saving mechanisms of the device 1100. For example, if the device 1100 is in an RRC_Connected state, where it is still connected to the RAN node as it expects to receive traffic shortly, then it can enter a state known as discontinuous reception mode (DRX) after a period of inactivity. During this state, the device 1100 can power down for brief intervals of time and thus save power.

If there is no data traffic activity for an extended period, then the device 1100 can transition off to an RRC_Idle state, where it disconnects from the network and does not perform operations such as channel quality feedback, handover, etc. The device 1100 goes into a very low power state and it performs paging where again it periodically wakes up to listen to the network and then powers down again. The device 1100 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1102 and processors of the baseband circuitry 1104 can be used to execute elements of one or more instances of a protocol stack. For example, processors of the baseband circuitry 1104, alone or in combination, can be used execute Layer 3, Layer 2, or Layer 1 functionality, while processors of the baseband circuitry 1104 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

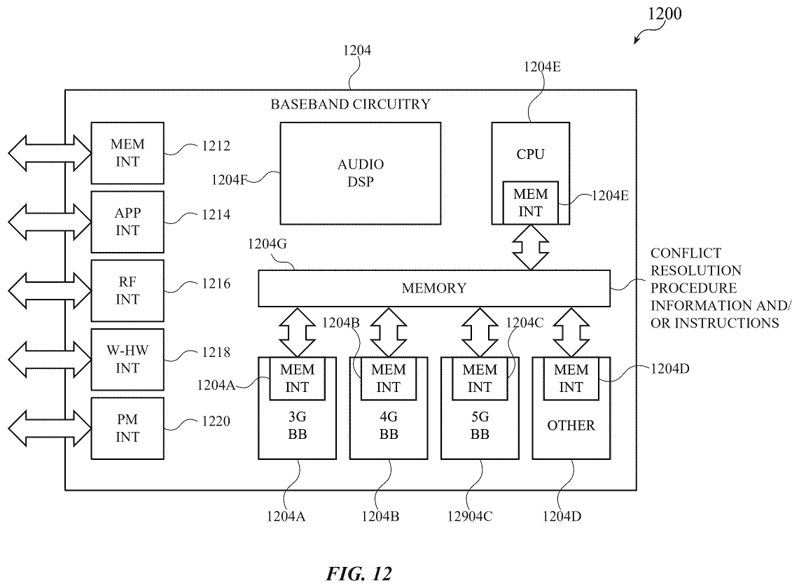

FIG. 12 is a diagram of example interfaces of baseband circuitry according to one or more implementations described herein. As discussed above, the baseband circuitry 1204 of FIG. 12 can comprise processors 1204A through 1104E and a memory 1204G utilized by said processors. Each of the processors 1204A through 1204E can include a memory interface, 1204A through 1204E, respectively, to send/receive data to/from the memory 1104G.

The baseband circuitry 1204 can further include one or more interfaces to communicatively couple to other circuitries/devices, such as a memory interface 1212 (e.g., an interface to send/receive data to/from memory external to the baseband circuitry 1204), an application circuitry interface 1214 (e.g., an interface to send/receive data to/from the application circuitry 1102 of FIG. 11), an RF circuitry interface 1216 (e.g., an interface to send/receive data to/from RF circuitry 1106 of FIG. 11), a wireless hardware connectivity interface 1218 (e.g., an interface to send/receive data to/from Near Field Communication (NFC) components, Bluetooth® components (e.g., Bluetooth® Low Energy), Wi-Fi® components, and other communication components), and a power management interface 1220 (e.g., an interface to send/receive power or control signals to/from the PMC 1112).

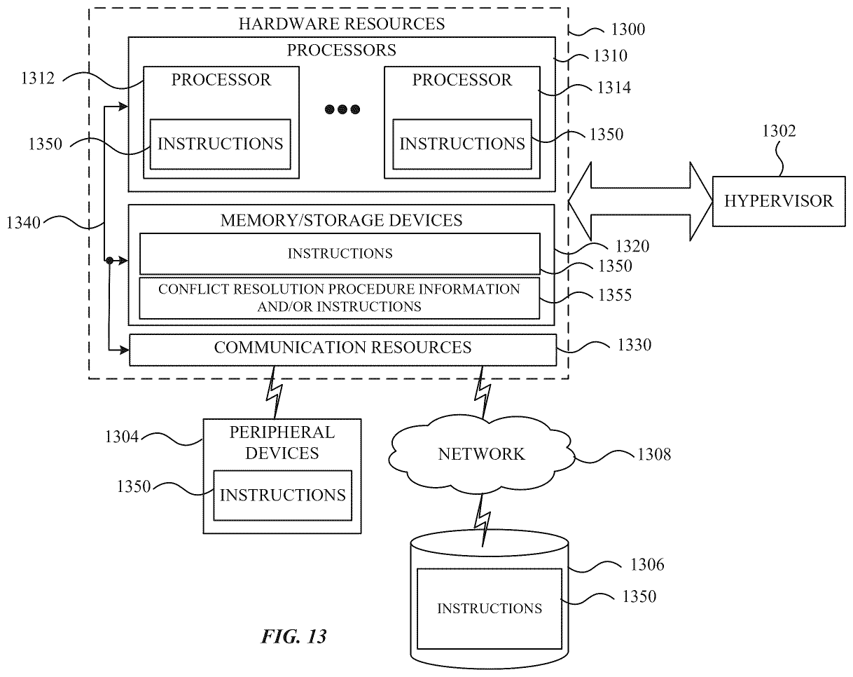

FIG. 13 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 13 shows a diagrammatic representation of hardware resources 1300 including one or more processors (or processor cores) 1310, one or more memory/storage devices 1320, and one or more communication resources 1330, each of which may be communicatively coupled via a bus 1340. For implementations where node virtualization (e.g., NFV) is utilized, a hypervisor may be executed to provide an execution environment for one or more network slices/sub-slices to utilize the hardware resources 1300.

The processors 1310 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1312 and a processor 1314.

The memory/storage devices 1320 may include main memory, disk storage, or any suitable combination thereof. The memory/storage devices 1320 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1320 may receive and store one or more configurations, instructions, and/or other types of information 1355 to enable conflict avoidance procedures and/or prioritization of uplink resources associated with a problematic band combination. When the UE is scheduled to perform uplink and downlink corresponding to a slot associated with a combination of problematic bands, the UE may forgo transmitting of the uplink communication. The UE may configure flexible slots to avoid such conflicts and/or to prioritize critical downlink and/or uplink communication. These and many other features and examples are described herein and may be enabled by the configurations, instructions, and/or other types of information stored by memory/storage devices 1320.

The communication resources 1330 may include interconnection or network interface components or other suitable devices to communicate with one or more peripheral devices 1304 or one or more databases 1306 via a network 1308. For example, the communication resources 1330 may include wired communication components (e.g., for coupling via a universal serial bus (USB)), cellular communication components, NFC components, Bluetooth® components (e.g., Bluetooth® low energy), Wi-Fi® components, and other communication components.

Instructions 1350 may comprise software, a program, an application, an applet, an app, or other executable code for causing at least any of the processors 1310 to perform any one or more of the methodologies discussed herein. The instructions 1350 may reside, completely or partially, within at least one of the processors 1310 (e.g., within the processor's cache memory), the memory/storage devices 1320, or any suitable combination thereof. Furthermore, any portion of the instructions 1350 may be transferred to the hardware resources 1300 from any combination of the peripheral devices 1304 or the databases 1306. Accordingly, the memory of processors 1310, the memory/storage devices 1320, the peripheral devices 1304, and the databases 1306 are examples of computer-readable and machine-readable media.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, baseband circuitry comprising a memory; and one or more processors configured to, when executing instructions stored in the memory, cause the baseband circuitry to: determine, based on a configuration by a base station (BS), a TDD band combination with at least 2 carrier components available in uplink determine to transmit or receive at a slot of at least one of a plurality of carrier components of the TDD band combination, according to a conflict resolution procedure; and transmit or receive at the slot based on the determination to transmit or receive.

In example 2, which may also include one or more of the examples described herein, to determine to transmit or receive at the slot according to the conflict resolution procedure, the one or more processors are configured to cause the baseband circuitry to: configure the baseband circuitry to receive at the slot, and configure the baseband circuitry to forgo transmitting at the slot, wherein the configuration by the base station includes an indication to transmit at the slot.

In example 3, which may also include one or more of the examples described herein, the conflict resolution procedure includes: determining that the baseband circuitry is to receive at the slot when the configuration by the base station indicates that the slot is a flexible slot format, and wherein the determining is based upon a hash map associated with a predetermined pattern of uplink and downlink.

In example 4, which may also include one or more of the examples described herein, the TDD band combination is associated with a dynamic pattern and indicates that a first carrier component of the at least 2 carrier components corresponds to an uplink configuration, and that a second carrier component of the at least 2 carrier components corresponds to a flexible configuration at the slot, and to determine to transmit or receive at the slot according to the conflict resolution procedure, the one or more processors are configured to cause the baseband circuitry to: configure the baseband circuitry for uplink via the first carrier component and for uplink via the second carrier component.

In example 5, which may also include one or more of the examples described herein, the conflict resolution procedure is terminated when one or more criteria, including a first criterion is satisfied when a block error rate (BLER) and the one or more criteria include a criterion satisfied when the BLER is equal to or greater than 5%.

In example 6, which may also include one or more of the examples described herein, a second criterion is satisfied when a channel condition parameter is beyond a range of values.

In example 7, which may also include one or more of the examples described herein, to determine to transmit or receive at the slot according to the conflict resolution procedure, the one or more processors are configured to cause the baseband circuitry to: when a first carrier component corresponds to an uplink direction at the slot, and a second carrier component corresponds corresponding to a flexible configuration, determine to transmit via the first carrier component and via the second carrier component, and when the first carrier component corresponds to a downlink direction at the slot and the second carrier component corresponds to the flexible configuration, determine to receive via the first carrier component and via the second carrier component.

In example 8, which may also include one or more of the examples described herein, the conflict resolution procedure includes configuring the baseband circuitry to forgo transmitting or receiving of one or more symbols corresponding to the slot.

In example 9, which may also include one or more of the examples described herein, to determine to transmit or receive at the slot according to the conflict resolution procedure, the one or more processors are configured to cause the baseband circuitry to: determine that a first carrier component of the at least 2 carrier components corresponds to a flexible or uplink configuration at the slot, and that a second carrier component of the at least 2 carrier components corresponds to the flexible or the uplink configuration at the slot, and apply a dynamic pattern to select resources for the transmitting or receiving.

In example 10, which may also include one or more of the examples described herein, to apply the dynamic pattern, the one or more processors are configured to cause the baseband circuitry to: configure the baseband circuitry to transmit at the slot via the first carrier component and via the second carrier component, wherein the transmitting includes transmitting of information that satisfies one or more criteria.

In example 11, which may also include one or more of the examples described herein, the information satisfies the one or more criteria when the information corresponds to one or more of: a random access channel (RACH) request, scheduling request (SR), voice over new radio (VoNR), voice over long-term evolution (VoLTE), ultra-reliable low latency communications (URLLC), augmented reality (AR) data, mixed reality (XR) data, and virtual reality (VR) data.

In example 12, which may also include one or more of the examples described herein, the configuration by the base station is included in a RRC message.

In example 13, which may also include one or more of the examples described herein, the TDD band combination is based on another configuration received by another base station, different from the base station.

In example 14, which may also include one or more of the examples described herein, a user equipment (UE) may comprise a memory; and one or more processors configured to, when executing instructions stored in the memory, cause the UE to: determine, based on a configuration by a base station (BS) a TDD band combination with at least 2 carrier components available in uplink; and determine to transmit or receive at a slot of at least one of a plurality of carrier components of the TDD band combination, according to a conflict resolution procedure; and transmit or receive at the slot based on the determination to transmit or receive.

In example 15, which may also include one or more of the examples described herein, to determine to transmit or receive at the slot according to the conflict resolution procedure, the one or more processors are configured to cause the UE to: configure the UE to receive at the slot, and configure the UE to forgo transmitting at the slot, wherein the configuration by the base station includes an indication to transmit at the slot.

In example 16, which may also include one or more of the examples described herein, a base station (BS) may comprise: a memory; and one or more processors configured to, when executing instructions stored in the memory, cause the BS to: transmit a configuration to a user equipment (UE) to determine a TDD band combination with at least 2 component carriers available in the uplink to the UE; receive from the UE at a slot, wherein the slot is based upon a determination of a conflict resolution procedure determined at the UE.

In example 17, which may also include one or more of the examples described herein, the base station is configured as a primary cell, secondary cell, primary secondary cell, or a switching secondary cell that serves the UE.

In example 18, which may also include one or more of the examples described herein, the one or more processors are further configured to cause the BS to: transmit one or more symbols that the UE uses to determine a block error rate (BLER) associated with communication between the BS and the UE, wherein receiving from the UE at the slot is based upon a determination that the BLER is within a range of BLER values.

In example 19, which may also include one or more of the examples described herein, the configuration includes one or more indications of flexible slots included in a slot pattern, including an indication that the slot is a flexible slot.

In example 20, which may also include one or more of the examples described herein, the one or more symbols received from the UE at the slot correspond to one or more of a random access channel (RACH) request, scheduling request (SR), voice over new radio (VoNR), voice over long-term evolution (VoLTE), ultra-reliable low latency communications (URLLC), augmented reality (AR) data, mixed reality (XR) data, and virtual reality (VR) data.

In example 21, which may also include one or more of the examples described herein, a method may comprise: determining based on a configuration by a base station (BS), a TDD band combination with at least 2 carrier components available in uplink, determining to transmit or receive at a slot of at least one of a plurality of carrier components of the TDD band combination, according to a conflict resolution procedure, and transmitting or receiving at the slot based on the determination to transmit or receive.

In example 22, which may also include one or more of the examples described herein, a method may comprise: determining based on a configuration by a base station (BS), a TDD band combination with at least 2 carrier components available in uplink, determining to transmit or receive at a slot of at least one of a plurality of carrier components of the TDD band combination, according to a conflict resolution procedure, and transmitting or receiving at the slot based on the determination to transmit or receive.

In example 23, which may also include one or more of the examples described herein, a method may comprise: at a base station (BS), transmitting a configuration to a user equipment (UE) to determine a TDD band combination with at least 2 component carriers available in the uplink to the UE; and receiving from the UE at a slot, wherein the slot is based upon a determination of a conflict resolution procedure determined at the UE.

In example 24, which may also include one or more of the examples described herein, a computer-readable medium may comprise one or more instructions that when executed by one or more processors may cause the one or more processors to perform one or more of the methods described herein.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A baseband circuitry comprising:
a memory; and
one or more processors configured to, when executing instructions stored in the memory, cause the baseband circuitry to:
determine, based on a configuration by a base station (BS), a TDD band combination with at least 2 carrier components available in uplink;
determine to transmit or receive at a slot of at least one of a plurality of carrier components of the TDD band combination, according to a conflict resolution procedure; and
transmit or receive at the slot based on the determination to transmit or receive.

2. The baseband circuitry of claim 1, wherein, to determine to transmit or receive at the slot according to the conflict resolution procedure, the one or more processors are configured to cause the baseband circuitry to:
configure the baseband circuitry to receive at the slot, and
configure the baseband circuitry to forgo transmitting at the slot, wherein the configuration by the base station includes an indication to transmit at the slot.

3. The baseband circuitry of claim 1, wherein the conflict resolution procedure includes:
determining that the baseband circuitry is to receive at the slot when the configuration by the base station indicates that the slot is a flexible slot format, and wherein the determining is based upon a hash map associated with a predetermined pattern of uplink and downlink.

4. The baseband circuitry of claim 1, wherein:
the TDD band combination is associated with a dynamic pattern and indicates that a first carrier component of the at least 2 carrier components corresponds to an uplink configuration, and that a second carrier component of the at least 2 carrier components corresponds to a flexible configuration at the slot, and
to determine to transmit or receive at the slot according to the conflict resolution procedure, the one or more processors are configured to cause the baseband circuitry to:
configure the baseband circuitry for uplink via the first carrier component and for uplink via the second carrier component.

5. The baseband circuitry of claim 1, wherein the conflict resolution procedure is terminated when one or more criteria are satisfied, including a first criterion is satisfied when a block error rate (BLER) is equal to or greater than 5%.

6. The baseband circuitry of claim 5, wherein a second criterion is satisfied when a channel condition parameter is beyond a range of values.

7. The baseband circuitry of claim 1, wherein, to determine to transmit or receive at the slot according to the conflict resolution procedure, the one or more processors are configured to cause the baseband circuitry to:
when a first carrier component corresponds to an uplink direction at the slot, and a second carrier component corresponds corresponding to a flexible configuration at the slot, determine to transmit via the first carrier component and via the second carrier component, and
when the first carrier component corresponds to a downlink direction at the slot and the second carrier component corresponds to the flexible configuration, determine to receive via the first carrier component and via the second carrier component.

8. The baseband circuitry of claim 1, wherein the conflict resolution procedure includes configuring the baseband circuitry to forgo transmitting or receiving of one or more symbols corresponding to the slot.

9. The baseband circuitry of claim 1, wherein to determine to transmit or receive at the slot according to the conflict resolution procedure, the one or more processors are configured to cause the baseband circuitry to:
determine that a first carrier component of the at least 2 carrier components corresponds to a flexible or uplink configuration at the slot, and that a second carrier component of the at least 2 carrier components corresponds to the flexible or the uplink configuration at the slot, and
apply a dynamic pattern to select resources for the transmitting or receiving.

10. The baseband circuitry of claim 9, wherein, to apply the dynamic pattern, the one or more processors are configured to cause the baseband circuitry to:
configure the baseband circuitry to transmit at the slot via the first carrier component and via the second carrier component, wherein the transmitting includes transmitting of information that satisfies one or more criteria.

11. The baseband circuitry of claim 10, wherein the information satisfies the one or more criteria when the information corresponds to one or more of: a random access channel (RACH) request, scheduling request (SR), voice over new radio (VoNR), voice over long-term evolution (VoLTE), ultra-reliable low latency communications (URLLC), augmented reality (AR) data, mixed reality (XR) data, and virtual reality (VR) data.

12. The baseband circuitry of claim 1, wherein the configuration by the base station is included in a RRC message.

13. The baseband circuitry of claim 1, wherein the TDD band combination is based on another configuration received by another base station, different from the base station.

14. A user equipment (UE) comprising:
a memory; and
one or more processors configured to, when executing instructions stored in the memory, cause the UE to:
determine, based on a configuration by a base station (BS) a TDD band combination with at least 2 carrier components available in uplink; and
determine to transmit or receive at a slot of at least one of a plurality of carrier components of the TDD band combination, according to a conflict resolution procedure; and
transmit or receive at the slot based on the determination to transmit or receive.

15. The UE of claim 14, wherein, to determine to transmit or receive at the slot according to the conflict resolution procedure, the one or more processors are configured to cause the UE to:
configure the UE to receive at the slot, and
configure the UE to forgo transmitting at the slot, wherein the configuration by the base station includes an indication to transmit at the slot.

16. A base station (BS) comprising:
a memory; and
one or more processors configured to, when executing instructions stored in the memory, cause the BS to:
transmit a configuration to a user equipment (UE) to determine a TDD band combination with at least 2 component carriers available in uplink to the UE; and
receive from the UE at a slot, wherein the slot is based upon a determination of a conflict resolution procedure determined at the UE.

17. The base station of claim 16, wherein the base station is configured as a primary cell, secondary cell, primary secondary cell, or a switching secondary cell that serves the UE.

18. The base station of claim 16, wherein the one or more processors are further configured to cause the BS to:
transmit one or more symbols that the UE uses to determine a block error rate (BLER) associated with communication between the BS and the UE, wherein receiving from the UE at the slot is based upon a determination that the BLER is within a range of BLER values.

19. The base station of claim 16, wherein the configuration includes one or more indications of flexible slots included in a slot pattern, including an indication that the slot is a flexible slot.

20. The base station of claim 19, wherein one or more symbols received from the UE at the slot correspond to one or more of a random access channel (RACH) request, scheduling request (SR), voice over new radio (VoNR), voice over long-term evolution (VoLTE), ultra-reliable low latency communications (URLLC), augmented reality (AR) data, mixed reality (XR) data, and virtual reality (VR) data.
